(19) United States
(12) Patent Application Publication
(10) Pub. No.: US 2021/0061943 A1
(43) Pub. Date: Mar. 4, 2021

(54) Stable and Low Cure-Temperature 1K Polyisocyanate

(71) Applicant: Henkel AG & Co. KGaA, Duesseldorf (DE)

(72) Inventors: Bin Zhao, Shanghai (CN); Dongmei Shen, Shanghai (CN); Claudia Meckel-Jonas, Duesseldorf (DE); Uwe Franken, Dormagen (DE)

(21) Appl. No.: 17/096,736

(22) Filed: Nov. 12, 2020

Related U.S. Application Data
(63) Continuation of application No. PCT/CN2018/087477, filed on May 18, 2018.

(51) Int. Cl. C08G 18/79; C09J 7/35; C09J 175/04; C08G 18/10; C08G 18/80; C08G 18/50

(52) U.S. Cl. CPC C08G 18/798; C09J 7/35; C08G 18/5021; C08G 18/10; C08G 18/8016; C09J 175/04

(57) ABSTRACT

This invention relates to a surface-deactivated solid polyisocyanate and a thermally curable adhesive composition comprising the same, which are suitable for assembling articles of various substrates such as plastic materials. In particular, the present invention relates to a surface-deactivated solid polyisocyanate and a thermally curable adhesive composition comprising the same which is storage stable at room temperature, can be cured at a temperature lower than 100° C. and meanwhile have excellent adhesion and mechanical properties when cured.

### TECHNICAL FIELD

This invention relates to a surface-deactivated solid polyisocyanate and a thermally curable adhesive composition comprising the same, which are suitable for assembling articles of various substrates such as plastic materials. In particular, the present invention relates to a surface-deactivated solid polyisocyanate and a thermally curable adhesive composition comprising the same which is storage stable at room temperature, can be cured at a temperature lower than 100° C. and meanwhile have excellent adhesion and mechanical properties when cured.

### BACKGROUND OF THE INVENTION

In one-component polyurethane adhesive field, amine deactivated solid isocyanate system is one of general methods to prepare storage stable polyurethane adhesives. In this process, only a small proportion of isocyanate groups available at the surface of the solid isocyanate react with amine and this leads to superficial stabilization via the formation of a polyurea shell. Then the stabilized isocyanates are dispersed in the isocyanate curable resins for further curing. The stabilized isocyanates are more preferred produced directly in suspension of polyamines/polyols. When the stabilized dispersion is heated to a certain temperature, the shell structure could be destructed, and inside isocyanates could be released out and react with curing resins to form a whole polyurethane structure. Therefore, this process has several advantages, such as non-sensitive to moisture, fast curing, no volatile molecule emission.

In this system, amine system and alcohol system, have been developed according to the curing resins. Polyols used in alcohol system should be carefully selected to obtain good storage stability at room temperature. Normally, amine system has much better storage stability. Moreover, after curing, polyurethane structure formed from amine system containing more urea bonds, and thus has better mechanical properties and thermal stability than that from alcohol system. However, amine system needs higher curing temperature (normally above 100° C.) than alcohol system, which limits its use for plastic related applications, and thus attempts have been made to find improved polyurethane adhesives.

For example, U.S. Pat. No. 8,759,455 B2 discloses a single-component composition that can be cured in two stages, comprising at least one isocyanate polyurethane polymer; at least one blocked amine, with at least two blocked amino groups that can be activated hydrolytically; and at least one surface-deactivated polyisocyanate that is solid at room temperature. However, it is required to a higher curing temperature to cure the adhesive composition.

DE 3228724 A1 discloses heat-curable mixtures of polyisocyanate and polyol which have a long shelf life at room temperature. The polyisocyanate is in the form of discrete particles in the polyol, the polyisocyanate particles having been deactivated at their surface by means of compounds containing carboxyl groups, phenolic hydroxyl groups, amide groups or hydrazide groups.

U.S. Pat. No. 4,595,445 A discloses a thermosetting reactive adhesive comprising a surface-modified, finely-divided polyisocyanate wherein part of the isocyanate groups of the unmodified polyisocyanate have been deactivated, and a polyamine.

There is still a need to develop curable adhesive compositions based on solid polyisocyanates, which are stable at room temperature, can be cured under lower temperature, and meanwhile have excellent adhesive strength and mechanical strength to be used in the application of bonding various substrates, especially plastic materials.

### SUMMARY OF THE INVENTION

The present invention provides a stable and low cure-temperature 1K polyisocyanate, especially a surface-deactivated solid polyisocyanate which overcomes at least one of the abovementioned disadvantages of present solid polyisocyanates. The surface-deactivated solid polyisocyanates in this invention could significantly reduce curing temperature when cured compared to conventional polyurethane adhesives. The surface-deactivated solid polyisocyanate in this invention is storage stable at room temperature. Besides, the curable adhesive composition in this invention possesses excellent adhesion strength and mechanical strength when cured.

The present invention provides a surface-deactivated solid polyisocyanate, which is a reaction product of a solid polyisocyanate with
(1) an acid addition salt of a carboxylic acid and a first amine having a weight averaged molecular weight of 1,000 g/mol or more, in which the carboxyl acid has a linear or branched, C₁-C₂₀-alkyl or C₁-C₂₀-alkylene group and is optionally substituted by a primary hydroxyl group, and
(2) optionally a second amine having a weight averaged molecular weight of less than 1,000 g/mol.

The present invention also provides a thermally curable adhesive composition comprising the surface-deactivated solid polyisocyanate, and a cured product of the surface-deactivated solid polyisocyanate or the thermally curable adhesive composition according to the present invention.

The present invention also provides the use of the surface-deactivated solid polyisocyanate made of composite materials selected from plastic films, metal films, and metalized plastic films, wood, metal, polymeric plastics, glass and textiles.

### DETAILED DESCRIPTION OF THE INVENTION

In the following passages the present invention is described in more detail. Each aspect so described may be combined with any other aspect or aspects unless clearly indicated to the contrary. In particular, any feature indicated as being preferred or advantageous may be combined with any other feature or features indicated as being preferred or advantageous.

In the context of the present invention, the terms used are to be construed in accordance with the following definitions, unless a context dictates otherwise.

As used herein, the singular forms “a”, “an” and “the” include both singular and plural referents unless the context clearly dictates otherwise.

The terms “comprising”, “comprises” and “comprised of” as used herein are synonymous with “including”, “includes” or “containing”, “contains”, and are inclusive or open-ended and do not exclude additional, non-recited members, elements or process steps.

The recitation of numerical end points includes all numbers and fractions subsumed within the respective ranges, as well as the recited end points.

All references cited in the present specification are hereby incorporated by reference in their entirety.

Unless otherwise defined, all terms used in the disclosing the invention, including technical and scientific terms, have the meaning as commonly understood by one of the ordinary skill in the art to which this invention belongs to. By means of further guidance, term definitions are included to better appreciate the teaching of the present invention.

According to the present invention, surface-deactivated solid polyisocyanate, which is a reaction product of a solid polyisocyanate with an acid addition salt of a carboxylic acid and a first amine having a weight averaged molecular weight of 1,000 g/mol or more, and optionally a second amine having a weight averaged molecular weight of less than 1,000 g/mol, in which the carboxyl acid has a linear or branched, C₁-C₂₀-alkyl or C₁-C₂₀-alkylene group and is optionally substituted by a primary hydroxyl group.

As used herein, the term “polyisocyanate” means diisocyanates or higher polyisocyanates, such as tri isocyanates, tetraisocyanates, etc.

Any diisocyanates or higher polyisocyanates or mixtures thereof are suitable as starting components for the surface-deactivated polyisocyanates according to the invention, providing they have a melting point above 40° C., preferably above 80° C. These isocyanates may be aliphatic, cycloaliphatic, aryliphatic, heterocyclic, and, preferably, aromatic polyisocyanates.

Examples of the (non-deactivated) solid polyisocyanate are toluene diisocyanate (TDI), diphenylmethane diisocyanate (MDI), polymethylene polyphenyl isocyanate (PAPI), naphthalene diisocyanate (NDI), p-phenylene diisocyanate (PPDI), dimethyl biphenyl diisocyanate (TODD, 1,4-cyclohexane diisocyanate (CHDI), triphenylmethane triisocyanate (TTI), 4,4′,4″-thio-phosphoric acid triphenyl triisocyanate (TPTI), 2,2′-dimethyldiphenylmethane-3,3′,5,5′-tetraisocyanate (TPMMTI), IPDI trimer, TDI dimer, TDI trimer, MDI trimer. Preferably, the solid polyisocyanate is selected from 2,4-TDI, 2,6-TDI, 2,4-TDI dimer, 2,6-TDI dimer, and mixture thereof. Other suitable examples can be found in U.S. Pat. No. 4,585,445 A, which is incorporated herein by reference.

The polyisocyanate that is solid at room temperature (i.e. 23° C.) is preferably based on fine particles, with an average particle size in the range of 0.01 to 100 μm, preferably 0.1 to 50 μm, particularly 0.3 to 30 μm.

One particular type of the solid polyisocyanates suitable for the present invention is TDI dimer, such as urea of TDI or uretdione of TDI represented by Formula (I)

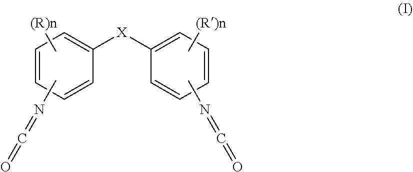

wherein X is

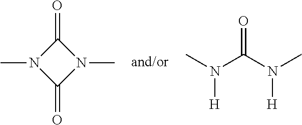

where n and m are identical or different and are 1, 2, 3 or 4, and R and R′ are identical or different and are C₁-C₄-alkyl.

In one more particular embodiment of the invention, the solid polyisocyanate is uretdione of 2,4-TDI, represented by Formula (II), and is commercially available, for example from Rhein Chemie Rheinau GmbH as Addolink TT.

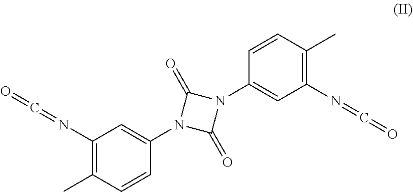 [SMILES: Cc1ccc(N2C(=O)N(c3ccc(C)c(N=C=O)c3)C2=O)cc1N=C=O]

The surface-deactivated polyisocyanate according to the present invention consists of particles of polyisocyanate that are solid at room temperature, the surfaces of which are covered or encapsulated with a varying thickness of a substance that is sufficiently impermeable and stable at room temperature to enclose the isocyanate groups inside the particles, and thus to make them inaccessible to chemical reaction partners, particular to compounds with active hydrogen atoms, and thus the polyisocyanate is surface deactivated. When heating the surface-deactivated polyisocyanate to a temperature of at least 60° C., and preferably at least 80° C., the layer on the polyisocyanate particles is damaged to such an extent that the isocyanate groups, within the particles, become accessible to chemical reactants, and hence are “activated”.

The surface-deactivated solid polyisocyanate is obtained from the reaction of the solid polyisocyanate with surface-deactivating compound having at least one isocyanate-reactive group, such as amine group. Through a chemical reaction on the surface of the polyisocyanate particles, a layer (“protective layer”) is formed that is resistant, i.e. impermeable and largely insoluble, at room, or slightly raised, temperature. A suitable compound for this reaction, referred to as “a surface-deactivating compound” comprises (1) an acid addition salt of a carboxylic acid and a first amine having a weight averaged molecular weight of 1,000 g/mol or more, in which the carboxyl acid comprises a linear or branched, C₁-C₂₀-alkyl or C₁-C₂₀-alkylene group optionally substituted by a primary hydroxyl group, and optionally (2) a second amine having a weight averaged molecular weight of less than 1,000 g/mol.

In choosing the surface-deactivating compound, it is important that the protective layer formed will be as resistant as possible with regard to all the substances present in the thermally curable adhesive composition in order to prevent the isocyanate groups of the surface-deactivated polyisocyanate from being activated prematurely, and cured during storage. It is also important to decrease the curing temperature of the surface-deactivated polyisocyanate so as to extend the application of the thermally curable adhesive composition based on the surface-deactivated polyisocyanate to lower melting point materials such as plastic materials.

Surprisingly, the inventors have found that the solid polyisocyanate surface deactivated at least by an acid addition salt of a carboxylic acid and a first amine having a longer chain has a lower curing temperature less than 100° C., and preferably less than 95° C. By the surface deactivation of such acid addition salt, the solid polyisocyanate is storage stable and not able to be cured at room temperature. When heated at an elevated temperature less than 110° C., preferably less than 95° C., the acid addition salt will release free carboxylic acid which breaks the formed covering layer, and renders the isocyanate groups in the solid particles to quickly react with the amine groups of the first amine. Meanwhile, the surface-deactivated solid polyisocyanate exhibited excellent adhesion ability such as lap shear strength to various substrates, good mechanical strength such as tensile strength, elongation and hardness.

The carboxylic acid suitable for the acid addition salt has a linear or branched, C₁-C₂₀-alkyl or C₁-C₂₀-alkylene group and is optionally substituted by a primary hydroxyl group. Preferably, the carboxylic acid has a linear or branched C₁ to C₁₆-alkyl group or C₁ to C₁₆-alkylene group, optionally substituted by a primary hydroxyl group. In particular, the carboxylic acid is a monocarboxylic acid having a linear or branched C₁ to C₁₆-alkyl group, dicarboxylic acid having a linear or branched C₁ to C₁₆-alkylene group, and/or a monocarboxylic acid having a linear or branched C₁ to C₁₆-alkyl group substituted by one or more primary hydroxy groups.

Examples of such carboxylic acid include, but not limited to aliphatic carboxylic acids include monocarboxylic acids such as formic acid, acetic acid, hydroxyacetic acid, propionic acid, isobutyric acid, 2-methylbutyric acid, octylic acid, 2-methylpentanoic acid, isononanoic acid, undecylenic acid, lauric acid, myristic acid, palmitic acid, behenic acid, stearic acid, isostearic acid, methoxyacetic acid, 2-hydroxymethylbutyric acid, dimethylolpropionic acid, dimethylolbutanoic acid, gluconic acid; dicarboxylic acids such as maleic acid, oxalic acid, malonic acid, succinic acid, glutaric acid, adipic acid, methylsuccinic acid, pemielic acid, azelaic acid, sebacic acid, dodecanedioic acid, brassylic acid, thapsic acid; and the like. Preferably, the carboxylic acid is selected from formic acid, acetic acid, hydroxyacetic acid, dimethylolpropanoic acid, dimethylolbutanoic acid, succinic acid, stearic acid, and mixture thereof.

The first amine used for the surface-deactivation of solid polyisocyanates can be any amino-functional compound having a long chain or large structure with higher molecular weight. These are preferably polyfunctional primary and secondary amines, particularly preferably polyfunctional aliphatic or aromatic amines. Amines suitable for the first amine of the present invention are particularly those selected from the group of cyclic and aliphatic, straight-chain or branched (C₂-C₁₄)-alkylamines, -diamines and -polyamines, in particular (C₂-C₁₀)-alkylamines, -diamines and -polyamines, preferably (C₂-C₆)-alkylamines, -diamines and -polyamines, which is interrupted in the alkyl chain by heteroatoms, in particular oxygen or sulphur, and/or where the alkyl chain can comprise further substituents, e.g. hydroxy groups, carboxy groups, halogen or the like.

In particular, the first amine having higher weight averaged molecular weight, i.e., 1,000 g/mol or more, preferably 1,500 g/mol or more, and more preferably 2,000 g/mol or more, as determined by gel permeation chromatography (GPC) using polystyrene standards, can be aliphatic, straight-chain or branched (C₂-C₁₄)-alkylamines, -diamines and -polyamines interrupted by oxygen atoms in the alkyl chain. Those are so called polyether amine compounds having higher molecular weight. In various embodiments, suitable first amines are polyether amines that contain primary and/or secondary amino groups, particularly terminal primary and/or secondary amino groups, attached to a polyether backbone. The polyether backbone can be based on repeat units of propylene glycol (PG), ethylene glycol (EG), mixed EG/PG, polytetramethylene glycol (PTMEG), and combinations thereof. Polyether amines having this core structure can be monoamines, diamines, or triamines.

Suitable polyether amines are represented by the following Formula (III):

R¹—(NHR²)ₘ (III)

In Formula (III), the group R¹ is a monovalent, divalent or trivalent polyether radical having at least 10, at least 15, at least 20, at least 30, at least 40, or at least 50 groups of formula —(R³—O)—, where R³ is a linear or branched alkylene having 1 to 4 carbon atoms, 2 to 4 carbon atoms or 2 to 3 carbon atoms. The group R² is hydrogen or alkyl (e.g., an alkyl having 1 to 10 carbon atoms, 1 to 6 carbon atoms, or 1 to 4 carbon atoms). The variable m is equal to 1, 2, or 3. The number average molecular weight of the second amine is no less than 1,000 grams/mole, preferably no less than 1,500 g/mol, and more preferably no less than 2,000 g/mol.

In some embodiments, the polyether amine of Formula (III) is a polyether monoamine of the following Formula (IV).

R⁴—(O—R⁵)_{q}—NH₂ (IV)

In Formula (IV), the group R⁴ is an alkyl having 1 to 4 carbon atoms, 1 to 3 carbon atoms or 1 carbon atom. Each group R⁵ is independently a branched or linear alkylene having 1 to 4 carbon atoms, 2 to 4 carbon atoms, or 2 to 3 carbon atoms. The variable q is equal to at least 10, at least 15, at least 20, or at least 30, at least 40, or at least 50. Examples of suitable monoamines of Formula V are commercially available from Huntsman Corporation under the trade name JEFFAMINE such as those in the JEFFAMINE M-series (e.g., M-1000, M-2005, M-2070).

In other embodiments, the polyether amine of Formula III is a polyether diamine of the following Formula (V).

H₂N—R⁶—(OR⁷)ₚ—NH₂ (V)

In Formula (V), each group of R⁶ and R⁷ is each independently a branched or linear alkylene having 1 to 4 carbon atoms, 2 to 4 carbon atoms, or 2 to 3 carbon atoms. The variable p is equal to at least 10, at least 15, at least 20, at least 30, at least 40, or at least 50. Examples of suitable diamines of Formula VI are commercially available from Huntsman Corporation under the trade name JEFFAMINE such as those in the JEFFAMINE D-series (e.g., D-2000, D-4000), the JEFFAMINE ED-series (e.g., ED-2003).

In still other embodiments, the polyether amine is a polyether triamine such as those commercially available from Huntsman Corporation under the trade name JEFFAMINE, such as those in the JEFFAMINE T-series (e.g., T-3000, T-5000) and from BASF under the trade name BAXXODUR (e.g., BAXXODUR (e.g., BAXXODUR EC 303, EC 310, and EC 311). In one particular embodiment, the first amine is a polyether triamine represented by Formula (VI)

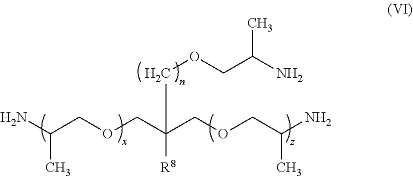

wherein R⁸ is hydrogen or (C₁-C₄)-alkyl, such as methyl, ethyl, n-propyl, n is from 1 to 10, and the sum of x, y and z is from about 20 to about 100, preferably from about 40 to about 90, such as about 50 or about 85.

In yet other embodiments, the polyether amine is a polyether diamine or polyether triamine having secondary amine groups. These polyether amines are N-alkylated polyether amines commercially available, for example, from Huntsman Corporation under the trade designation JEFFAMINE such as those in the JEFFAMINE SD-series (e.g. SD-2001).

According to the present invention, the molar ratio of the carboxylic acid to the first amine is in the range of from 0.1 to 10, and preferably from 0.5 to 3.

The preparation of the acid addition salt of a carboxylic acid and the first amine is known in the art. In general, the acid addition salt is prepared by mixing the carboxylic acid and the first amine in a mixer, and mechanical milling/stirring the mixture in sufficient time. Heat may be added to assist in the mixing and shorten the reaction time. Commercially available machines can be used for the stirring/milling process, examples being bead mills, dissolvers and/or blade stirrers.

In addition to the acid addition salt, the solid polyisocyanate may be optionally surface deactivated by a second amine having a weight averaged molecular weight of less than 1,000 g/mol, preferably less than 800, and more preferably less than 600.

The second amine used for the surface-deactivation of solid polyisocyanates can be any amino-functional compound having a short chain or small structure with lower molecular weight. Similar to the first amine, these are preferably polyfunctional primary and secondary amines, particularly preferably polyfunctional aliphatic or aromatic amines. Amines suitable for the second amine of the present invention are particularly those selected from the group of cyclic and aliphatic, straight-chain or branched (C₂-C₁₄)-alkylamines, -diamines and -polyamines, in particular (C₂-C₁₀)-alkylamines, -diamines and -polyamines, preferably (C₂-C₆)-alkylamines, -diamines and -polyamines, where there can be at least some, or else full, interruption of the alkyl chain by heteroatoms, in particular oxygen or sulphur, and/or where the alkyl chain can comprise further substituents, e.g. hydroxy groups, carboxy groups, halogen or the like.

In particular, the second amine having lower molecular weight, i.e., less than 1,000, can be aliphatic, straight-chain or branched (C₂-C₁₄)-alkylamines, -diamines and -polyamines interrupted by oxygen atoms in the alkyl chain. Those are so called polyether amine compounds. In various non-limiting embodiments, suitable second amine are polyether amines that contain primary and/or secondary amino groups, particularly terminal primary and/or secondary amino groups, attached to a polyether backbone. The polyether backbone can be based on repeat units of propylene glycol (PG), ethylene glycol (EG), mixed EG/PG, polytetramethylene glycol (PTMEG), and combinations thereof. Polyether amines having this core structure can be monoamines, diamines, or triamines.

Suitable polyether amines are represented by the following Formula (VII):

R⁹—(NHR¹⁰)ₙ (VII)

In Formula (VII), the group R⁹ is a monovalent, divalent or trivalent polyether radical having at least 2, at least 3, at least 5, at least 10, at least 20, or at least 30 groups of formula —(R⁹—O)—, where R⁹ is a linear or branched alkylene having 1 to 4 carbon atoms, 2 to 4 carbon atoms or 2 to 3 carbon atoms. The group R¹⁰ is hydrogen or alkyl (e.g., an alkyl having 1 to 10 carbon atoms, 1 to 6 carbon atoms, or 1 to 4 carbon atoms). The variable n is equal to 1, 2, or 3. The number average molecular weight of the second amine is less than 1,000 grams/mole, preferably less than 800 g/mol, and more preferably less than 600 g/mol.

In some embodiments, the polyether amine of Formula VII is a polyether monoamine of the following Formula VIII.

R¹¹—(O—R¹²)ₐ—NH₂ (VIII)

In Formula VIII, the group R¹¹ is an alkyl having 1 to 4 carbon atoms, 1 to 3 carbon atoms or 1 carbon atom. Each group R¹² is independently a branched or linear alkylene having 1 to 4 carbon atoms, 2 to 4 carbon atoms, or 2 to 3 carbon atoms. The variable q is equal to at least 2, at least 3, at least 5, or at least 10, at least 20, or at least 30. Examples of suitable monoamines of Formula VIII are commercially available from Huntsman Corporation under the trade name JEFFAMINE such as those in the JEFFAMINE M-series (e.g., M-600).

In other embodiments, the polyether amine of Formula VII is a polyether diamine of the following Formula IX.

H₂N—R¹³—(OR¹⁴)_{b}—NH₂ (IX)

In Formula IX, each group of R¹³ and R¹⁴ is each independently a branched or linear alkylene having 1 to 4 carbon atoms, 2 to 4 carbon atoms, or 2 to 3 carbon atoms. The variable b is equal to at least 2, at least 3, at least 5, at least 10, at least 20, or at least 30. Examples of suitable diamines of Formula IX are commercially available from Huntsman Corporation under the trade name JEFFAMINE such as those in the JEFFAMINE D-series (e.g., D-230, D400), JEFFAMINE HK-511, the JEFFAMINE ED-series (e.g., ED-600, ED-900), the JEFFAMINE EDR series (e.g., EDR-148, and EDR-176), or the JEFFAMINE THF series (e.g., THF-100, THF-140, and THF-170). Other examples of suitable diamines of Formula VI are commercially available from BASF (Florham Park, N.J.) under the trade name BAXXODUR (e.g., BAXXODUR EC-130 (4,7,10-trioxatridecane-1,13-diamine), and EC-280 (4,9-dioxadodecane-1,12-diamine).

In still other embodiments, the polyether amine is a polyether triamine such as those commercially available from Huntsman Corporation under the trade name JEFFAMINE, such as those in the JEFFAMINE T-series (e.g., T-403). In one particular embodiment, the second amine is a polyether triamine represented by Formula (X)

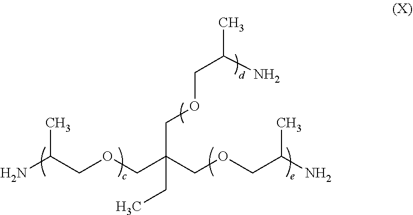

wherein the sum of c, d and e is 5 or 6.

In yet other embodiments, the polyether amine is a polyether diamine or polyether triamine having secondary amine groups. These polyether amines are N-alkylated polyether amines commercially available, for example, from Huntsman Corporation under the trade designation JEFFAMINE such as those in the JEFFAMINE SD-series or ST-series (SD-213, SD-401 and ST-404).

In yet other embodiments, the polyether amine is products from the addition reaction of primary aliphatic polyamines with Michael acceptors in a reaction like a Michael reaction, such as maleic acid diester, fumaric acid diester, citraconic acid diester, acrylic acid ester, methacrylic acid ester, cinnamic acid ester, itaconic acid diester, vinyl phosphonic acid diester, vinyl sulfonic acid aryl ester, vinyl sulfones, vinyl nitriles, 1-nitroethylenes or Knoevenagel condensation products such as, for example, those from malonic acid diesters and aldehydes such as formaldehyde, acetaldehyde or benzaldehyde as well as commercial secondary aliphatic polyamines such as Gaskamine 240 (from Mitsubishi), Desmophen NH 1220, NH 1420 and NH 1520 (from Covestro) or F220, F420, F520 (from Feiyang Chemicals).

In yet other embodiments, the polyether amine is primary and/or secondary aromatic polyamine such as in particular m- and p-phenylene diamine, 4,4′-,2,4′ and 2,2′-diaminodiphenylmethane, 3,3′-dichloro-4,4′-diaminodiphenylmethane (MOCA), 2,4- and 2,6-toluoylene diamine, mixtures of 3,5-dimethylthio-2,4- and -2,6-toluoylene diamine, mixtures of 3,5-diethyl-2,4- and -2,6-toluoylene diamine (DETDA), 3,3′,5,5′-tetraethyl-4,4′-diaminodiphenyl methane (M-DEA), 3,3′,5,5′-tetraethyl-2,2′-dichloro-4,4′-diaminodiphenyl methane (M-CDEA), 3,3′-diisopropyl-5,5′-dimethyl-4,4′-diaminodiphenyl methane (M-MIPA), 3,3′,5,5′-tetraisopropyl-4,4′-diaminodiphenyl methane (M-DIPA), 4,4′-diamino diphenylsulfone (DDS), 4-amino-N-(4-aminophenyl)benzene sulfonamide, 5,5′-methylenedianthranilic acid, dimethyl-(5,5′-methylene dianthranilate), 1,3-propylene-bis-(4-aminobenzoate), 1,4-butylene-bis-(4-aminobenzoate), polytetramethylene oxide-bis-(4-aminobenzoate) (obtainable as Versalink series from Evonik), 1,2-bis-(2-aminophenylthio)ethane, N,N′-dialkyl-p-phenylene diamine diphenyl methane, 2-methylpropyl-(4-chloro-3,5-diamino benzoate) and tert-butyl-(4-chloro-3,5-diamino benzoate).

The mass ratio of the second amine having lower molecular weight to the solid polyisocyanate is in the range of 0 to 0.1, and preferably from 0 to 0.064.

The molar ratio of the NCO groups to the sum of amine groups in the first amine and second amine is in the range of 0.8 to 10, and preferably from 1.2 to 4.

The preparation of surface-deactivated solid polyisocyanate is known to the art. In the present invention, the surface-deactivated solid polyisocyanate is prepared by mixing the acid addition salt of the first amine with the solid polyisocyanate in a mixer with stirring for sufficient time, for example, from 1 to 12 hours. If present, the second amine can be mixed with the first amine before the solid polyisocyanate is added.

The surface-deactivated solid polyisocyanate according to the present invention is storage stable under room temperature for at least 14 days. For example, if the surface-deactivated solid polyisocyanate is in the form of soft paste, it will not become a hard solid during the storage.

The surface-deactivated solid polyisocyanate according to the present invention can be cured under a temperature of 80 to 100° C., or even lower than 80° C., and thus is suitable to be used in the application of bonding plastic materials which have lower melting point.

To improve the thixotropy performance and adhesion, additives may be added in the surface-deactivated solid polyisocyanate. Therefore, the present invention also provides a thermally curable adhesive comprising the surface-deactivated solid polyisocyanate and option additives. The additives are selected from the group consisting of catalyst, adhesion promoter, filler and mixture thereof.

Catalysts may be contained in curable adhesive composition to facilitate the reaction between amines and isocyanates. Suitable metallic catalysts that accelerate the reaction of the isocyanate groups, are organotin compounds such as dibutyltin diacetate, dibutyltin dilaurate (DBTDL), dibutyltin dichloride, dibutyltin diacetylacetonate and dioctyltin dilaurate; compounds of zinc, manganese, iron, chromium, cobalt, copper, nickel, molybdenum, lead, cadmium, mercury, antimony, vanadium, titanium and potassium, especially zinc(II)-acetate, zinc(II)-2-ethylhexanoate, zinc(II)-laurate, zinc(II)-acetylacetonate, iron(III)-2-ethylhexanoate, Cobalt(II)-2-ethylhexanoate, copper(II)-2-ethylhexanoate, nickel(II)-naphthenate, aluminum lactate, aluminum oleate, diisopropoxytitanium-bis-(ethyl acetoacetate) and potassium acetate; tertiary amino group-containing compounds, especially 2,2′-dimorpholinodiethyl ether, 1,4-diazabicyclo[2.2.2]octane, N-ethyl-diiso-propylamine, N,N,N′,N′-tetramethyl-alkylenediamine, pentamethyl-alkylenetriamine and higher homologs thereof, bis-(N,N-diethylaminoethyl) adipate, tris-(3-dimethyl-aminopropyl)amine, 1,4-diazabicyclo[2.2.2]octane (DABCO), 1,8-diazabicyclo-[5.4.0]undec-7-ene (DBU), 1,5-diazabicyclo[4.3.0]non-5-ene (DBN), N-alkylmorpholines, N,N′-dimethylpiperazine; nitrogenaromatic compounds such as 4-dimethylaminopyridine, N-methylimidazole, N-vinylimidazole or 1,2-dimethylimidazole; organic ammonium compounds such as benzyltrimethylammonium hydroxide or alkoxylated tertiary amines. From about 0% to 5% by weight, and preferably 0.1% to 1.0% by weight of catalyst are optionally used in the adhesive composition.

The curable adhesive composition can optionally comprise an adhesion promoter or coupling agent which promotes bonding of the composition to a substrate. Examples are organo-silanes which can link the solid polyisocyanate to the surface such as amino silanes and epoxy silanes. Some exemplary aminosilane adhesion promoters include 3-aminopropyltrimethoxysilane, 3-aminopropyltriethoxysilane, N-(2-aminoethyl-3-aminopropyl)trimethoxysilane, 3-aminopropylmethyldiethoxysilane, 4-amino-3,3-dimethylbutyltrimethoxysilane, N-(n-butyl)-3-aminopropyltrimethoxysilane, 1-butanamino-4-(dimethoxymethylsilyl)-2,2-dimethyl, (N-cyclohexylaminomethyl)triethoxysilane, (N-cyclohexylaminomethyl)-methyldiethoxysilane, (N-phenylaminoethyl)trimethoxysilane, (N-phenylaminomethyl)-methyldimethoxysilane or gamma-ureidopropyltrialkoxysilane. Aminosilanes with oligomeric structures such as Sivo 203 and Dynasylan AMMO from Evonik Corp. Particularly preferred amino silanes include 3-aminopropyltrimethoxysilane, 3-aminopropyltriethoxysilane, and N-Butyl-3-(trimethoxysilyl)propylamine. Some exemplary epoxy silane adhesion promoters include 3-glycidyloxypropyltrimethoxysilane, 3-glycidyloxypropyltriethoxysilane or beta-(3,4-epoxycyclohexyl)ethyltrimethoxysilane. Other silane adhesion promoters include mercaptosilanes. Some exemplary mercaptosilane adhesion promoters include 3-mercaptopropyltrimethoxysilane, 3-mercaptopropylmethyldimethoxysilane or 3-mercaptopropyltriethoxysilane. If used, the level of adhesion promoter employed can be from 0% by weight to about 10% by weight, preferably 0.01% by weight to 5% by weight and more preferably 0.1% by weight to 2% by weight.

The curable adhesive composition can optionally include filler. Some useful fillers include, for example, lithopone, zirconium silicate, hydroxides, such as hydroxides of calcium, aluminum, magnesium, iron and the like, diatomaceous earth, carbonates, such as sodium, potassium, calcium, and magnesium carbonates, oxides, such as zinc, magnesium, chromic, cerium, zirconium and aluminum oxides, calcium clay, nanosilica, fumed silicas, silicas that have been surface treated with a silane or silazane such as the AEROSIL products available from Evonik Industries or CAB-O-SIL products available from Carbot Corp., silicas that have been surface treated with an acrylate or methacrylate such as AEROSIL R7200 or R711 available from Evonik Industries, precipitated silicas, untreated silicas, graphite, synthetic fibers and mixtures thereof. When used, filler can be employed in concentrations effective to provide desired properties in the uncured composition and cured reaction products and typically in concentrations of about 0% to about 80% by weight of composition, more typically 1% to 60% by weight of composition of filler.

The curable adhesive composition can optionally include a thixotrope or rheology modifier. The thixotropic agent can modify rheological properties of the uncured composition. Some useful thixotropic agents include, for example, silicas, such as fused or fumed silicas, that may be untreated or treated so as to alter the chemical nature of their surface. Virtually any reinforcing fused, precipitated silica, fumed silica or surface treated silica may be used.

Examples of treated fumed silicas include polydimethylsiloxane-treated silicas, hexamethyldisilazane-treated silicas and other silazane or silane treated silicas. Such treated silicas are commercially available, such as from Cabot Corporation under the tradename CAB-O-SIL ND-TS and Evonik Industries under the tradename AEROSIL, such as AEROSIL R805. Also useful are the silicas that have been surface treated with an acrylate or methacrylate such as AEROSIL R7200 or R711 available from Evonik Industries. Examples of untreated silicas include commercially available amorphous silicas such as AEROSIL 300, AEROSIL 200 and AEROSIL 130. Commercially available hydrous silicas include NIPSIL E150 and NIPSIL E200A manufactured by Japan Silica Kogya Inc. The rheology modifier can be employed in concentrations effective to provide desired physical properties in the uncured composition and cured reaction products and typically in concentrations of about 0% to about 70% by weight of composition and advantageously in concentrations of about 0% to about 20% by weight of composition. In certain embodiments the filler and the rheology modifier can be the same.

The curable adhesive composition can optionally include an anti-oxidant. Some useful antioxidants include those available commercially from BASF under the tradename IRGANOX. When used, the antioxidant should be used in the range of about 0 to about 15 weight percent of curable composition, such as about 0.3 to about 1 weight percent of curable composition.

The curable adhesive composition can optionally include a reaction modifier. A reaction modifier is a material that will increase or decrease reaction rate of the curable composition. For example, 8-hydroxyquinoline (8-HQ) and derivatives thereof such as 5-hydroxymethyl-8-hydroxyquinoline can be used to adjust the cure speed. When used, the reaction modifier can be used in the range of about 0.001 to about 15 weight percent of curable composition.

The curable adhesive composition can optionally contain a thermoplastic polymer. The thermoplastic polymer may be either a functional or a non-functional thermoplastic. Example of suitable thermoplastic polymers include acrylic polymer, functional (e.g. containing reactive moieties such as —OH and/or —COOH) acrylic polymer, non-functional acrylic polymer, acrylic block copolymer, acrylic polymer having tertiary-alkyl amide functionality, polysiloxane polymer, polystyrene copolymer, polyvinyl polymer, divinylbenzene copolymer, polyetheramide, polyvinyl acetal, polyvinyl butyral, polyvinyl acetate, polyvinyl chloride, methylene polyvinyl ether, cellulose acetate, styrene acrylonitrile, amorphous polyolefin, olefin block copolymer, polyolefin plastomer, thermoplastic urethane, polyacrylonitrile, ethylene vinyl acetate copolymer, ethylene vinyl acetate terpolymers, functional ethylene vinyl acetate, ethylene acrylate copolymer, ethylene acrylate terpolymer, ethylene butadiene copolymer and/or block copolymer, styrene butadiene block copolymer, and mixtures of any of the above.

The curable composition can optionally include one or more coloring agents. For some applications a colored composition can be beneficial to allow for inspection of the applied composition. A coloring agent, for example a pigment or dye, can be used to provide a desired color beneficial to the intended application.

Exemplary coloring agents include titanium dioxide, C.I. Pigment Blue 28, C.I. Pigment Yellow 53 and phthalocyanine blue BN. In some applications a fluorescent dye can be added to allow inspection of the applied composition under UV radiation. The coloring agent will be present in amounts sufficient to allow observation or detection, for example about 0.002% or more by weight of total composition. The maximum amount is governed by considerations of cost, absorption of radiation and interference with cure of the composition. More desirably, the coloring agent may be present in amounts of up to about 20% by weight of total composition.

The curable composition can optionally include from about 0% to about 20% by weight, for example about 1% to about 20% by weight of composition of other additives known in the arts, such as tackifier, plasticizer, flame retardant, moisture scavenger, and combinations of any of the above, to produce desired functional characteristics, providing they do not significantly interfere with the desired properties of the curable composition or cured reaction products of the curable composition.

When used as a one-part solid polyisocyanate adhesive, the curable adhesive compositions do not include solvent which is added by intention. This type of adhesives is known as non-solvent adhesives.

In one particular embodiment, the thermally curable adhesive composition comprises
(1) 20% to 80%, preferably 40% to 60% by weight of a surface-deactivated solid polyisocyanate according to the present invention,
(2) 0% to 5%, preferably 0.1% to 1% by weight of a catalyst,
(3) 0% to 10%, preferably 0.01% to 5% by weight of an adhesion promoter, and
(4) 0% to 80%, preferably 1% to 60% by weight of a filler.

Also disclosed in the present invention is a method of preparing a solid polyisocyanate, comprising mixing the carboxylic acid and a first amine to obtain an acid addition salt, and mixing the acid addition salt and optionally the second amine, with the solid polyisocyanate. Typically the components are mixed using static mixers or with the aid of dynamic mixers. During mixing, it is to make sure that the components are mixed as homogeneously as possible.

An additional object of the invention is thus a cured product obtained from the curing of a surface-deactivated solid polyisocyanate or a thermally curable adhesive composition as described in the present document. The cured products are storage-stable under room temperature, and have lower curing temperature than conventional polyurethanes and other adhesives. The cured products are also expected to have excellent adhesion strength and mechanical strength. The disclosed surface-deactivated solid polyisocyanate and curable adhesive compositions will be useful wherever these properties are desirable.

Adhesive compositions disclosed herein can be used to bond articles together. Under appropriate conditions for the type of composition the adhesive composition is applied to a first article and a second article is disposed in contact with the adhesive composition applied to the first article. The adhesive composition may be heated under a temperature higher than the softening point and lower than the curing temperature for the convenience of application. After applied, the adhesive composition is exposed to conditions (such as heating to the curing temperature of from 80 to 100° C., or even lower than 80° C.) to promote curing. Cured reaction products of the adhesive composition bond the first and second articles. The disclosed adhesive compositions are useful for bonding articles composed of a wide variety of substrates (materials), including but not limited to flexible films such as plastic films, metal films, and metalized plastic films, wood, metal, polymeric plastics, glass and textiles. The present adhesive composition is particularly suitable for plastic materials due to the lower curing temperature. Plastic materials may be for example polyvinyl chloride (hard and soft PVC), acrylonitrile-butadiene-styrene copolymers (ABS), polycarbonate (PC), polyamide (PA), polyester, poly(methyl methacrylate) (PMMA), polyesters, epoxy resins, polyurethanes (PUR), polyoxymethylene (POM), polyolefins (PO), polyethylene (PE) or polypropylene (PP), ethylene/propylene copolymers (EPM) and ethylene/propylene/diene terpolymers (EPDM), wherein the plastic materials can preferably be surface-treated with plasma, corona or flame. Other applications include adhesives for bonding electronic components in OLEDs and LCDs, bonding hand held electronic devices such as cell phones, bonding photovoltaics, conformal coatings such as for electronic components and adhesives for backbedding or glazing windows.

In one embodiment, the surface-deactivated solid polyisocyanate or the thermally curable adhesive composition comprising the same according to the present invention is stable under room temperature for 14 days or more.

The use of the solid composition results in an article containing the cured product. This article is especially a structure, especially an above-ground or below-ground structure, or an item of industrial or consumer goods, especially a window, a household appliance, a rotor blade of a wind-power plant or a means of transportation, especially a vehicle, preferably an automobile, a bus, a truck, a train or a ship, as well as an airplane or a helicopter; or a mounted part of such an article, or an article from the furniture, textile or packaging industry.

The following examples are intended to assist one skilled in the art to better understand and practice the present invention. The scope of the invention is not limited by the examples but is defined in the appended claims. All parts and percentages are based on weight unless otherwise stated.

### EXAMPLES

The following materials were used in the examples.

Acetic acid is commercially available from Aldrich.

Formic acid is commercially available from Aldrich.

Hydroxyacetic acid is commercially available from Aldrich.

Stearic acid is commercially available from Aldrich.

Succinic acid is commercially available from Aldrich.

2,2-dimethylolbutanoic acid is commercially available from Aldrich.

2,2-dimethylolpropanoic acid is commercially available from Aldrich.

Salicylic acid is commercially available from Aldrich.

Barbituric acid is commercially available from Aldrich.

Phosphorous acid is commercially available from Aldrich.

Aluminium chloride is commercially available from Aldrich.

Lactic acid is commercially available from Aldrich.

D-2000 is a polyether diamine having a Mw of about 2,000, commercially available from Huntsman Corporation under the trade name JEFFAMINE D-2000.

T-5000 is a polyether triamine having a Mw of about 5,000, commercially available from Huntsman Corporation under the trade name JEFFAMINE T-5000.

T-3000 is a polyether triamine having a Mw of about 3,000, commercially available from Huntsman Corporation under the trade name JEFFAMINE T-3000.

T-403 is a polyether triamine having a Mw of about 440, commercially available from Huntsman Corporation under the trade name JEFFAMINE T-403.

P-650 is a polytetramethyleneoxide-di-p-aminobenzoate having a Mw of about 830, commercially available from Evonik under the tradename of Versalink P-650.

F420 is an aspartic ester amine commercially available from Feiyang Chemicals under the tradename of F420.

Addolink TT is a uretdione of 2,4-TDI, commercially available, from Rhein Chemie Rheinau GmbH under the trade name of Addolink TT.

Aluminium hydroxide is commercially available from Huber under the tradename of Martinal OL-107.

Fumed silica is commercially available from Cabot under the tradename of CAB-O-SIL TS-720.

Dynasylan AMMO is adhesion promoter commercially available from Evonik.

HMGPE-5000 is a polyether triol having a Mw of about 5,000, commercially available from Zhejiang Huangma Technology Co., LTD.

DBTDL is dibutyltin dilaurate commercially available from Aldrich.

### Example 1 (Ex 1)

1.14 grams of acetic acid and 34 grams of T-5000 were added in a 100-mL flask. The mixture was stirred overnight. Then resulting acid addition salt, and 5 grams of Addolink TT were added in a Speed mixer Max40 (from FlackTek Inc.), and then mixed by a Speed mixer DAC400 (from FlackTek Inc.) to obtain a white paste product.

### Example 2

1.14 grams of acetic acid and 19 grams of T-3000 were added in a 100-mL flask. The mixture was stirred overnight. Then resulting acid addition salt and 5 grams of Addolink TT were added in a Speed mixer Max40 (from FlackTek Inc.), and then mixed by a Speed mixer DAC400 (from FlackTek Inc.) to obtain a white paste product.

### Example 3

0.44 grams of formic acid and 17 grams of T-5000 were added in a 100-mL flask. The mixture was stirred overnight. Then resulting acid addition salt, 0.04 grams of T-403 and 2.5 grams of Addolink TT were added in a Speed mixer Max40 (from FlackTek Inc.), and then mixed by a Speed mixer DAC400 (from FlackTek Inc.) to obtain a white paste product.

### Example 4

0.72 grams of hydroxyacetic acid and 17 grams of T-5000 were added in a 100-mL flask. The mixture was heated to 40° C. and stirred overnight. Then resulting acid addition salt, 0.04 grams of T-403 and 2.5 grams of Addolink TT were added in a Speed mixer Max40 (from FlackTek Inc.), and then mixed by a Speed mixer DAC400 (from FlackTek Inc.) to obtain a white paste product.

### Example 5

2.71 grams of stearic acid and 17 grams of T-5000 were added in a 100-mL flask. The mixture was heated to 80° C. and stirred overnight. Then resulting acid addition salt, 0.04 grams of T-403, 2.5 grams of Addolink TT, 8 grams of aluminium hydroxide, 2 grams of fumed silica, and 0.06 grams of Dynasylan AMMO were added in a Speed mixer Max40 (from FlackTek Inc.), and then mixed by a Speed mixer DAC400 (from FlackTek Inc.) to obtain a white paste product.

### Example 6

0.56 grams of succinic acid and 17 grams of T-5000 were added in a 100-mL flask. The mixture was heated to 140° C. and stirred until all of the solid dissolved. The mixture was cooled to 60° C. and stirred overnight. Then resulting acid addition salt, 0.04 grams of T-403 and 2.5 grams of Addolink TT were added in a Speed mixer Max40 (from FlackTek Inc.), and then mixed by a Speed mixer DAC400 (from FlackTek Inc.) to obtain a white paste product.

### Example 7

2.82 grams of 2,2-dimethylolbutanoic acid and 34 grams of T-5000 were added in a 100-mL flask. The mixture was heated to 110° C. and stirred until all of the solid dissolved. The mixture was cooled to 60° C. and stirred overnight. Then resulting acid addition salt, 0.08 grams of T-403 and 5.0 grams of Addolink TT were added in a Speed mixer Max40 (from FlackTek Inc.), and then mixed by a Speed mixer DAC400 (from FlackTek Inc.) to obtain a white paste product.

### Example 8

2.55 grams of 2,2-dimethylolpropanoic acid and 34 grams of T-5000 were added in a 100-mL flask. The mixture was heated to 140° C. and stirred until all of the solid dissolved. The mixture was cooled to 60° C. and stirred overnight. Then resulting acid addition salt, 0.08 grams of T-403 and 5.0 grams of Addolink TT were added in a Speed mixer Max40 (from FlackTek Inc.), and then mixed by a Speed mixer DAC400 (from FlackTek Inc.) to obtain a white paste product.

### Example 9

1.14 grams of acetic acid and 19.04 grams of D-2000 were added in a 100-mL flask. The mixture was stirred overnight. Then resulting acid addition salt, 0.08 grams of T-403 and 5.0 grams of Addolink TT were added in a Speed mixer Max40 (from FlackTek Inc.), and then mixed by a Speed mixer DAC400 (from FlackTek Inc.) to obtain a white paste product.

### Example 10

0.57 grams of acetic acid and 17.0 grams of T-5000 were added in a 100-mL flask. The mixture was stirred overnight. Then resulting acid addition salt, 0.04 grams of T-403, 2.5 grams of Addolink TT, 8 grams of aluminium hydroxide, 2 grams of fumed silica, and 0.06 grams of Dynasylan AMMO were added in a Speed mixer Max40 (from FlackTek Inc.), and then mixed by a Speed mixer DAC400 (from FlackTek Inc.) to obtain a white paste product.

### Comparative Example 1 (CE 1)

34 grams of HMGPE-5000, 5.0 grams of Addolink TT, and 0.08 grams of DBTDL were added in a Speed mixer Max40 (from FlackTek Inc.), and then mixed by a Speed mixer DAC400 (from FlackTek Inc.) to obtain a white paste product.

### Comparative Example 2

19 grams of T-3000 and 5.0 grams of Addolink TT were added in a Speed mixer Max40 (from FlackTek Inc.), and then mixed by a Speed mixer DAC400 (from FlackTek Inc.) to obtain a white paste product.

### Comparative Example 3

34 grams of T-5000, 0.08 grams of T-403 and 5.0 grams of Addolink TT were added in a Speed mixer Max40 (from FlackTek Inc.), and then mixed by a Speed mixer DAC400 (from FlackTek Inc.) to obtain a white paste product.

### Comparative Example 4

1.31 grams of salicylic acid and 17.0 grams of T-5000 were added in a 100-mL flask. The mixture was heated to 140° C. and stirred until all of the solid dissolved. The mixture was cooled to 60° C. and stirred overnight. Then resulting acid addition salt, 0.04 grams of T-403 and 2.5 grams of Addolink TT were added in a Speed mixer Max40 (from FlackTek Inc.), and then mixed by a Speed mixer DAC400 (from FlackTek Inc.) to obtain a white paste product.

### Comparative Example 5

2.14 grams of acetic acid and 7.92 grams of P-650 were added in a 100-mL flask. The mixture was heated to 40° C. and stirred overnight. Then resulting acid addition salt, 0.08 grams of T-403 and 5.0 grams of Addolink TT were added in a Speed mixer Max40 (from FlackTek Inc.), and then mixed by a Speed mixer DAC400 (from FlackTek Inc.) to obtain a white paste product.

### Comparative Example 6

1.15 grams of acetic acid and 5.27 grams of F420 were added in a 100-mL flask. The mixture was heated to 40° C. and stirred overnight. Then resulting acid addition salt, 0.08 grams of T-403 and 5.0 grams of Addolink TT were added in a Speed mixer Max40 (from FlackTek Inc.), and then mixed by a Speed mixer DAC400 (from FlackTek Inc.) to obtain a white paste product.

### Comparative Example 7

2.44 grams of barbituric acid and 34 grams of T-5000 were added in a 100-mL flask. The mixture was heated to 120° C. and stirred overnight. Then resulting acid addition salt, 0.08 grams of T-403 and 5.0 grams of Addolink TT were added in a Speed mixer Max40 (from FlackTek Inc.), and then mixed by a Speed mixer DAC400 (from FlackTek Inc.) to obtain a white paste product.

### Comparative Example 8

0.74 grams of phosphorous acid and 34 grams of T-5000 were added in a 100-mL flask. The mixture was stirred overnight. Then resulting acid addition salt, 0.08 grams of T-403 and 5.0 grams of Addolink TT were added in a Speed mixer Max40 (from FlackTek Inc.), and then mixed by a Speed mixer DAC400 (from FlackTek Inc.) to obtain a white paste product.

### Comparative Example 9

2.54 grams of aluminium chloride and 34 grams of T-5000 were added in a 100-mL flask. The mixture was stirred overnight. Then resulting acid addition salt, 0.08 grams of T-403 and 5.0 grams of Addolink TT were added in a Speed mixer Max40 (from FlackTek Inc.), and then mixed by a Speed mixer DAC400 (from FlackTek Inc.) to obtain a white paste product.

### Comparative Example 10

0.86 grams of lactic acid and 17 grams of T-5000 were added in a 100-mL flask. The mixture was stirred overnight. Then resulting acid addition salt, 0.04 grams of T-403 and 2.5 grams of Addolink TT were added in a Speed mixer Max40 (from FlackTek Inc.), and then mixed by a Speed mixer DAC400 (from FlackTek Inc.) to obtain a white paste product.

### Performance Evaluation

### Storage Stability

The surface-deactivated solid polyisocyanate obtained in each example was placed in a plastic container under room temperature (about 25° C.) for two weeks, and observed whether the solid polyisocyanate was cured on each day. If the paste product became a hard solid, the storage stability was evaluated as “Fail”, and if the paste form was maintained after two weeks, the storage stability was evaluated as “Pass”.

### Curing Temperature

The curing temperature of each surface-deactivated solid polyisocyanate was measure by Differential scanning calorimetry (DSC) with the following ramp program: equilibrating at 20° C., and heating from 20° C. to 250° C. with a heating rate of 10° C./min. The temperature indicating the maximum peak was recorded as the curing temperature.

### Hardness, Tensile Strength, Elongation at Break and Lap Shear Strength

The surface-deactivated solid polyisocyanate obtained from each example was cured under a temperature higher than respective curing temperature. The hardness of the cured product was measured according to ASTM D2240. The tensile strength was measured according to ASTM D412, the elongation at break was measured according to ASTM D412, and the lap shear adhesive strength was measured according to ASTM D1002 (substrate: 6061A1) and D3163 (substrate: PA, PC, PMMA). The results of the evaluation are shown in Tables 1 and 2.

TABLE 1
Results of evaluation on storage stability and curing temperature

| Item | Ex 1 | Ex 2 | Ex 3 | Ex 4 | Ex 5 | Ex 6 | Ex 7 | Ex 8 | Ex 9 | Ex 10 |
|---|---|---|---|---|---|---|---|---|---|---|
| Storage stability | Pass | Pass | Pass | Pass | Pass | Pass | Pass | Pass | Pass | Pass |
| Curing temperature (° C.) | 90.6 | 82.1 | 81.5 | 79.4 | 94.0 | 87.6 | 80.1 | 81.6 | 78.8 | 89.0 |
| Item | CE 1 | CE 2 | CE 3 | CE 4 | CE 5 | CE 6 | CE 7 | CE 8 | CE 9 | CE 10 |
| Storage stability | Pass | Pass | Pass | Fail | Fail | Pass | Pass | Pass | Fail | Fail |
| Curing temperature (° C.) | 104.8 | 99.7 | 130.1 | 81.7 | N.D.¹ | 115.3 | 108.0 | 70.0 | 101.0 | 127.4 |

¹The cured product was not available for test as it was cured within one hour.

TABLE 2
Results of evaluation on hardness, elongation, tensile strength and lap shear strength

| Item | Ex 2 | Ex 3 | Ex 5 | Ex 7 | Ex 9 | Ex 10 | CE 8 |
|---|---|---|---|---|---|---|---|
| Hardness (Shore A) | 76.0 | 69.0 | 68.1 | 63.6 | 70.2 | 73.6 | 23.0 |
| Tensile strength (MPa) | 2.77 | 2.99 | 3.16 | 2.77 | 4.08 | 5.15 | 0.36 |
| Elongation at break (%) | 64.0 | 130 | 100 | 181 | 186 | 80.0 | 28.0 |
| Lap shear strength (MPa) - 6061Al | 0.73 | 2.04 | 0.6 | 2.18 | 1.66 | 2.31 | N.D.² |
| Lap shear strength (MPa) - PA | 1.91 | 2.03 | 2.16 | 1.57 | 3.11 | 3.55 | 0.11 |
| Lap shear strength (MPa) - PC | 3.36 | 1.53 | 4.53 | 1.30 | 3.87 | 4.68 | 1.25 |
| Lap shear strength (MPa) - PMMA | 0.99 | 0.56 | 0.63 | 0.76 | 1.33 | 1.94 | 0.45 |

²The value was lower than the detection limit.

As shown in Tables 1 and 2, the surface-deactivated solid polyisocyanates or thermally curable adhesives according to the present invention exhibited a curing temperature of less than 95° C., a storage stability of more than 2 weeks, and good adhesion and mechanical strength when applied onto various substrates. Compared to the inventive examples, the conventional polyisocyanate systems containing polyol (CE 1), surface-deactivated by amines (CEs 2 and 3), amines blocked by aromatic carboxyl acid (CE 4), heterocyclic carboxyl acid (CE 7), inorganic acids (CEs 8 and 9) and carboxyl acid substituted by secondary hydroxy only (CE 10), short chain amines blocked by acid (CEs 5 and 6) exhibited at least one of the drawbacks including a significantly higher curing temperature (more than 95° C.), poor storage stability under room temperature (less than 2 weeks), and poor adhesion and/or mechanical strength.

What is claimed is:

1. A surface-deactivated solid polyisocyanate, which is a reaction product of a solid polyisocyanate with
(1) an acid addition salt of a carboxylic acid and a first amine having a weight averaged molecular weight of 1,000 g/mol or more, in which the carboxyl acid has a linear or branched, C₁-C₂₀-alkyl or C₁-C₂₀-alkylene group and is optionally substituted by a primary hydroxyl group, and
(2) optionally a second amine having a weight averaged molecular weight of less than 1,000 g/mol.

2. The surface-deactivated solid polyisocyanate according to claim 1, wherein the solid polyisocyanate is selected from 2,4-TDI, 2,6-TDI, 2,4-TDI dimer, 2,6-TDI dimer, urea of TDI, uretdione of TDI and mixtures thereof.

3. The surface-deactivated solid polyisocyanate according to claim 1, wherein the solid polyisocyanate is represented by Formula (I) 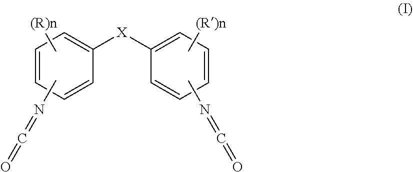
wherein X is 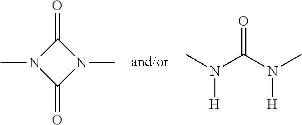
where n and m are identical or different and are 1, 2, 3 or 4, and R and R′ are identical or different and are C₁-C₄-alkyl.

4. The surface-deactivated solid polyisocyanate according to claim 1, wherein the solid polyisocyanate in particle form with an average particle size in the range of 0.01 to 100 μm.

5. The surface-deactivated solid polyisocyanate according to claim 1, wherein the second amine is a polyether amine having a weight averaged molecular weight of less than 800.

6. The surface-deactivated solid polyisocyanate according to claim 1, wherein the first amine is a polyether amine having a weight averaged molecular weight of 1,500 or more.

7. The surface-deactivated solid polyisocyanate according to claim 1, wherein the carboxylic acid is selected from a monocarboxylic acid having a linear or branched C₁ to C₁₆-alkyl group, a dicarboxylic acid having a linear or branched C₁ to C₁₆-alkylene group, a monocarboxylic acid having a linear or branched C₁ to C₁₆-alkyl group substituted by one or more primary hydroxy groups, and mixtures thereof.

8. The surface-deactivated solid polyisocyanate according to claim 1, wherein the carboxylic acid is selected from formic acid, hydroxyacetic acid, dimethylolpropanoic acid, dimethylolbutanoic acid, succinic acid, stearic acid, and mixtures thereof.

9. The surface-deactivated solid polyisocyanate according to claim 1, wherein the weight ratio of the carboxylic acid to the first amine is in the range of from 0.1 to 10.

10. The surface-deactivated solid polyisocyanate according to claim 1, wherein the weight ratio of the second amine to the solid polyisocyanate is in the range of from 0 to 0.1.

11. The surface-deactivated solid polyisocyanate according to claim 1, which is stable under room temperature for 14 days or more.

12. The surface-deactivated solid polyisocyanate according to claim 1, which can be cured at a temperature lower than 100° C.

13. The surface-deactivated solid polyisocyanate according to claim 1, which can be cured at a temperature in the range of 60 to 95° C.

14. A storage stable, thermally curable adhesive composition, comprising the surface-deactivated solid polyisocyanate according to claim 1, and optionally at least one additive.

15. A cured product of the storage stable, thermally curable adhesive composition according to claim 14.

16. A cured product of the surface-deactivated solid polyisocyanate according to claim 1.

17. A method for bonding articles, comprising:
providing a storage stable, thermally curable adhesive composition, comprising the surface-deactivated solid polyisocyanate according to claim 1, and optionally at least one additive,
applying the storage stable, thermally curable adhesive composition to a first substrate,
bringing a second substrate into contact with the storage stable, thermally curable adhesive composition applied to the first substrate to form an assembly, and
subjecting the assembly to a temperature of from 80 to 100° C. for a time sufficient to cure the thermally curable adhesive composition and bond the first substrate to the second substrate.

18. An article comprising a first substrate bonded to a second substrate by cured reaction products of an adhesive composition comprising the surface-deactivated solid polyisocyanate of claim 1, wherein each of the substrates is independently selected from plastic film, metal film, metalized plastic film, wood, metal, polymeric plastic, glass, ceramic and textile.

19. A method of preparing a storage stable, surface deactivated solid polyisocyanate, comprising,
mixing a carboxylic acid having a linear or branched, C₁-C₂₀-alkyl or C₁-C₂₀-alkylene group and optionally substituted by a primary hydroxyl group with a first amine having a weight averaged molecular weight of 1,000 g/mol or more to obtain an acid addition salt, and
mixing the acid addition salt, and optionally a second amine having a weight averaged molecular weight of less than 1,000 g/mol with a solid polyisocyanate to form the storage stable, surface deactivated solid polyisocyanate.
